(19) United States
(12) Patent Application Publication
(10) Pub. No.: US 2026/0307694 A1
(43) Pub. Date: Oct. 8, 2026

(54) MONITORING SYSTEM AND METHOD

(71) Applicant: Transportation IP Holdings, LLC, Norwalk, CT (US)

(72) Inventors: Ankit Mathur, Bengaluru (IN); Milan Karunaratne, Orange, CA (US); Anthony D. Paul, Anchorage, AK (US); Jeremiah Dirnberger, Jacksonville, FL (US)

(73) Assignee: Transportation IP Holdings, LLC, Norwalk, CT (US)

(21) Appl. No.: 19/449,052

(22) Filed: Jan. 14, 2026

Related U.S. Application Data
(63) Continuation-in-part of application No. 19/178,515, filed on Apr. 14, 2025.
(63) Continuation-in-part of application No. 17/983,516, filed on Nov. 9, 2022, now Pat. No. 12,530,794.
Application No. 19/178,515 is a continuation of application No. 17/221,039, filed on Apr. 2, 2021, now Pat. No. 12,286,145.

(30) Foreign Application Priority Data
Nov. 24, 2021 (IN) 202111054199

(51) Int. Cl. B61L 25/02; B61L 1/16; B61L 27/40; B61L 27/70; B61L 17/02; G06V 20/54; G07C 5/08

(52) U.S. Cl. CPC B61L 25/028; B61L 1/163; B61L 1/166; B61L 25/021; B61L 27/40; B61L 27/70; B61L 17/02; B61L 2205/04; G06V 20/54; G07C 5/0825; G07C 5/0866

(57) ABSTRACT

A monitoring system for identifying vehicle systems within a yard is recited. One or more cameras is positioned at the yard and each has a field of view that has at least a portion of one or more routes within the yard. The one or more cameras captures image data of vehicle systems within the field of view. One or more processors receives the image data captured by the one or more cameras, detects, in the image data, identification devices positioned on exterior surface of the vehicle systems within the yard, and identifies the vehicle systems within the yard based on the detected identification devices.

### CROSS REFERENCE TO RELATED APPLICATIONS

This application is a continuation-in-part of U.S. Patent Application Serial No. 19/178,515, entitled VEHICLE CONTROL SYSTEM, filed April 14, 2025, which is a continuation under 35 U.S.C. § 120 of U.S. Patent Application Serial No. 17/221,039, entitled VEHICLE CONTROL SYSTEM, filed April 2, 2021, now U.S. Patent No. 12,286,145 issued April 29, 2025, and this application is a continuation-in-part of U.S. Patent Application Serial No. 17/983,516, entitled MONITORING SYSTEM AND METHOD, filed November 9, 2022, which claims priority to and the benefit of India Patent Application No. 202111054199, filed November 24, 2021, the contents of which are hereby incorporated by reference herein in their entirety.

### BACKGROUND

### Technical Field

The subject matter described herein relates to monitoring systems and methods.

### Discussion of Art

Vehicles that are part of a fleet, or operate to carry cargo or passengers, typically have common locations or areas where many of the vehicles are located at the same time. For example, airplanes congregate at an airport, ships at a dock, automobiles at parking garages, rail vehicles at a yard or depot, etc. For some of these vehicles, such as airplanes, ships, rail vehicles, etc. the vehicle can remain at the location for an extended period of time, including days or even weeks. For example, for rail vehicles, one common area is a rail yard. In a rail yard, the rail vehicles load and unload cargo, obtain maintenance, exchange cars, or the like.

To best optimize yard operations, rail vehicle movements with the yard can be observed and logged. Specifically, a group of trained professionals are tasked with watching the movements of the rail vehicles each day the rail vehicles are in the yard. Such a process is lengthy, time consuming, and inefficient. Additionally, the process is subject to human error, movements of vehicles occurring during a time the professional is not in the yard, miscommunications, or the like.

When a camera is installed within a facility, or if the camera is moved to a new position, the camera needs to be trained on what the camera is able to see, what the camera should see, and what the camera should ignore, within the field of view of the camera. As one example, the camera may be moved to an intersection of intersecting routes within a city, and a field of view of the camera may include buildings, roads, the intersecting routes, sidewalks, landscapes, vehicles, pedestrians, etc. In order for the camera to know what the camera is to monitor, the camera needs to be trained on what to monitor and/or what to ignore. For example, the camera may need to be trained to monitor only an intersection of two or more routes, and ignore pedestrian movement within the field of view, ignore movement of vehicles and/or pedestrians along other routes, ignore movement of vehicles along the routes outside of the intersection, or the like.

To train the camera on what objects the camera is to monitor during an upcoming monitoring session, an operator may receive all of the visual data from the camera, and may manually indicate which portions of the visual data is to be monitored (e.g., which routes, which types of vehicles, or the like), and which background portions of the visual data is to be ignored. This process of training the camera may take multiple days to complete. Additionally, the camera is required to be re-trained if the camera is moved to a new or different location.

Therefore, a need exists for a system and method to automatically determine a position of a camera based on known details of an area to be monitored and known position details of the asset moving or positioned within the area to be monitored.

### BRIEF DESCRIPTION

In one or more embodiments, a control system is provided that may include a first sensor configured to detect a vehicle system. The control system may also include one or more processors in communication with the first sensor. The one or more processors may be configured to receive communication related to entry of the vehicle system into an area, and operate the first sensor to begin monitoring the vehicle system in response to entry of vehicle system into the area. The one or more processors may also be configured to record movement data related to the vehicle system, and determine movement of the vehicle system within the area based on the movement data.

In one or more embodiments, a method is provided that may include receiving, at a transceiver, location data related to a vehicle system into an area. The method may also include detecting, within a first sensor field of view of a first sensor, a first movement characteristic of the vehicle system on a first route in response to receiving the location data. The method may also include varying the first sensor field of view of the first sensor based on the first movement characteristic detected, and recording, in a storage device, movement data related to the vehicle system obtained from the first sensor.

In one or more embodiments, a control system is provided and may include a camera configured to detect a vehicle system and two or more routes, and a controller including one or more processors in communication with the camera. The one or more processors may be configured to receive communication related to location data of the vehicle system, and operate the camera to begin monitoring at least one of the vehicle system or the two or more routes in response to receiving the communication related to the location data of the vehicle system. The one or more processors may also be configured to log data related to the vehicle system or the two or more routes, and communicate the data logged related to the vehicle system and the two or more routes.

In accordance with one example or aspect, a method may include receiving details of an area to be monitored, and receiving one of a) position details of an asset moving within a field of view of the area to be monitored, or b) position details of a camera configured to monitor the area. The method may include determining one of c) a position of the camera responsive to receiving the position details of the asset moving within the field of view of the area; or d) a position of the asset moving within the field of view responsive to receiving the position details of the camera.

In accordance with one example or aspect, a monitoring system may include a camera to monitor a first area, and a controller comprising one or more processors. The controller may receive sensed data from the camera. The processors may include details of the first area to be monitored. The processors may receive one of a) position details of an asset moving within a field of view of the first area to be monitored, or b) position details of a camera configured to monitor the first area. The processors may determine one of c) a position of the camera responsive to receiving the position details of the asset moving within the field of view of the first area, or d) a position of the asset moving within the field of view responsive to receiving the position details of the camera.

In accordance with one example or aspect, a method may include receiving one of a) position details of an asset moving within a field of view of an area to be monitored, or b) position details of a camera configured to monitor the area. The method may include determining one of c) a position of the camera responsive to receiving the position details of the asset moving within the field of view, or d) a position of the asset moving within the field of view responsive to receiving the position details of the camera. The method may include monitoring the area, detecting movement of one or more objects within the field of view of the area with the camera, determining that at least one of the one or more objects moving within the area one or more of along a prohibited pathway or within a prohibited region, and communicating an alert responsive to the at least one object moving one or more of along the prohibited pathway or within the prohibited region.

In one aspect, the present disclosure provides a monitoring system for identifying vehicle systems within a yard. The monitoring system includes one or more cameras. The one or more cameras is positioned at the yard and each has a field of view that includes at least a portion of one or more routes within the yard. The one or more cameras captures image data of vehicle systems within the field of view. The monitoring system further includes one or more processors. The one or more processors receives the image data captured by the one or more cameras. The one or more processors further detects, in the image data, identification devices positioned on exterior surface of the vehicle systems within the yard. The one or more processors further identifies the vehicle systems within the yard based on the detected identification devices.

In one aspect, the present disclosure provides a monitoring system. The monitoring system includes identification devices each determining unique identity data of a plurality of vehicle systems along one or more routes. The monitoring system further includes one or more processors. The one or more processors receives the determined identity data of the plurality of vehicle systems from the identification devices. The one or more processors further identifies the plurality of vehicle systems along the one or more routes based on the received identity data of the plurality of vehicle systems.

In one aspect, the present disclosure provides a method. The method includes capturing, via one or more cameras, image data of identification devices of a plurality of vehicle systems along one or more routes within a field of view of the one or more cameras. The method further includes identifying, via the one or more processors, the plurality of the vehicle systems along the one or more routes based on the captured image data.

### BRIEF DESCRIPTION OF THE DRAWINGS

The inventive subject matter may be understood from reading the following description of non-limiting embodiments, with reference to the attached drawings, wherein below:

FIG. 1 illustrates a block schematic diagram of a vehicle system according to at least one aspect of the present disclosure;

FIG. 2 illustrates a schematic view of a control system within an area according to at least one aspect of the present disclosure;

FIG. 3 illustrates block schematic diagram of a controller according to at least one aspect of the present disclosure;

FIG. 4 illustrates a block schematic diagram of a method of controlling movement of a vehicle system in an area according to at least one aspect of the present disclosure;

FIG. 5 illustrates a monitoring system according to at least one aspect of the present disclosure;

FIG. 6 illustrates a control system of the monitoring system shown in FIG. 5 according to at least one aspect of the present disclosure;

FIG. 7 illustrates a flowchart of a method of monitoring an area according to at least one aspect of the present disclosure;

FIG. 8 illustrates a schematic of one example for receiving position details of an asset according to at least one aspect of the present disclosure.

FIG. 9 illustrates one example of monitoring an area with a monitoring system according to at least one aspect of the present disclosure;

FIG. 10 illustrates one example of monitoring an area with a monitoring system according to at least one aspect of the present disclosure;

FIG. 11 illustrates one example of monitoring a first area with a camera of a monitoring system in a first position according to at least one aspect of the present disclosure;

FIG. 12 illustrates one example of monitoring a second area with a camera of a monitoring system in a second position according to at least one aspect of the present disclosure;

FIG. 13 illustrates a monitoring system that monitors plural different areas in accordance according to at least one aspect of the present disclosure; and

FIG. 14 illustrates a logic diagram of a method for monitoring according to at least one aspect of the present disclosure.

### DETAILED DESCRIPTION

Embodiments of the subject matter described herein relate to a control system that monitors locations and/or movement of vehicles within an area related to a vehicle such as a rail vehicle. The dimensions of the area can be identified by the control system upon receiving location data, such as global navigation satellite system (GNSS) coordinates from a vehicle. Optionally, the dimensions of the area can be predetermined or based on manual input. The control system utilizes sensors, such as cameras or other optical sensors, to provide data (e.g., video feeds, recorded videos, infrared data, etc.) of the area. The sensors can be placed at different locations to capture activity, including movement data, within the area. One or more of the sensors may dynamically vary the field of view of the sensor to track each vehicle within the area. This includes movement of the sensor through rotation, translation, pitch, yaw, etc. of the sensor, varying a lens or zoom of a sensor, etc. Such dynamic variance may be based on the movement data, entry of the vehicle system into the area, movement data of another vehicle in the area, or the like. In this manner, each sensor may have a different monitoring zone than one or more (or all) other sensors, and be operated to work together with the other sensors to provide movement data related to the entire area. For example, each sensor can monitor a different portion of the area, and the data output by several of the sensors can be combined (e.g., stitched together) to monitor the entire area even in situations where a single sensor does not or is incapable of monitoring the entire area. The movement data of each vehicle in the area can be recorded, or logged to be utilized in determining future movements of each vehicle in the area, and for future vehicles that will enter the area. Such determinations facilitate functionality within the area, and improve efficiencies.

Not all embodiments described herein are limited to rail vehicle systems. For example, one or more embodiments of the control systems and methods described herein can be used in connection with other types of vehicles, such as automobiles, trucks, buses, mining vehicles, marine vessels, aircraft, agricultural vehicles, forklifts, or the like.

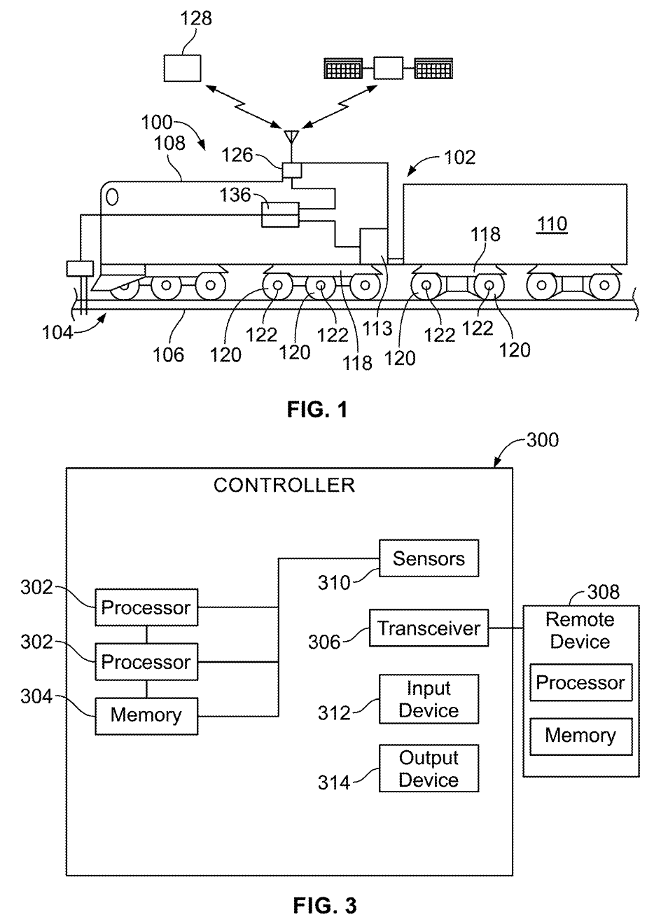

FIG. 1 illustrates a schematic diagram of one example of a vehicle system 100 that includes a control system 102. The vehicle system may be configured to travel along a route 104 on a trip from a starting or departure location to a destination or arrival location. The vehicle system includes a propulsion-generating vehicle 108 and a non-propulsion-generating vehicle 110 that are mechanically interconnected to one another to travel together along the route. The vehicle system may include at least one propulsion-generating vehicle and optionally, one or more non-propulsion-generating vehicles. Alternatively, the vehicle system may be formed of only a single propulsion-generating vehicle.

The propulsion-generating vehicle may generate tractive efforts to propel (for example, pull or push) the vehicle system along routes. The propulsion-generating vehicle includes a propulsion subsystem, such as an engine, one or more traction motors, and/or the like, that operate to generate tractive effort to propel the vehicle system. The propulsion-generating vehicle also includes a braking system 112 that generates braking effort to slow or stop movement of the vehicle system. Although one propulsion-generating vehicle and one non-propulsion-generating vehicle are shown in FIG. 1, the vehicle system may include multiple propulsion-generating vehicles and/or multiple non-propulsion-generating vehicles. In an alternative embodiment, the vehicle system only includes the propulsion-generating vehicle such that the propulsion-generating vehicle is not coupled to the non-propulsion-generating vehicle or another kind of vehicle. In yet another embodiment, the vehicles in the vehicle system are logically or virtually coupled together, but not mechanically coupled together.

In the example of FIG. 1, the vehicles of the vehicle system each include multiple wheels 120 that engage the route and at least one axle 122 that couples left and right wheels together (only the left wheels are shown in FIG. 1). Optionally, the wheels and axles are located on one or more trucks or bogies 118. Optionally, the trucks may be fixed-axle trucks, such that the wheels are rotationally fixed to the axles, so the left wheel rotates the same speed, amount, and at the same times as the right wheel. In one embodiment, the vehicle system may not include axles, such as in some mining vehicles, electric vehicles, etc.

The control system may further include a wireless communication system 126 that allows wireless communications between vehicles in the vehicle system and/or with remote locations, such as the remote (e.g., dispatch) location 128. The communication system may include a receiver and a transmitter, or a transceiver that performs both receiving and transmitting functions. The communication system may also include an antenna and associated circuitry.

The vehicle system may also include a locator device 136. The locator device may be positioned on the vehicle system, utilize wayside devices, etc. In one example, the locator device is a GNSS receiver, such as a global positioning system (GPS) receiver that receives signals from remote sources (e.g., satellites) for use in determining locations, movements, headings, speeds, etc., of the vehicles, and can provide position data related to the vehicle system. Alternatively, the locator device may use WiFi, Bluetooth-enabled beacons, near-field communication (NFC), radio frequency identification (RFID), QR code, etc. to provide location information.

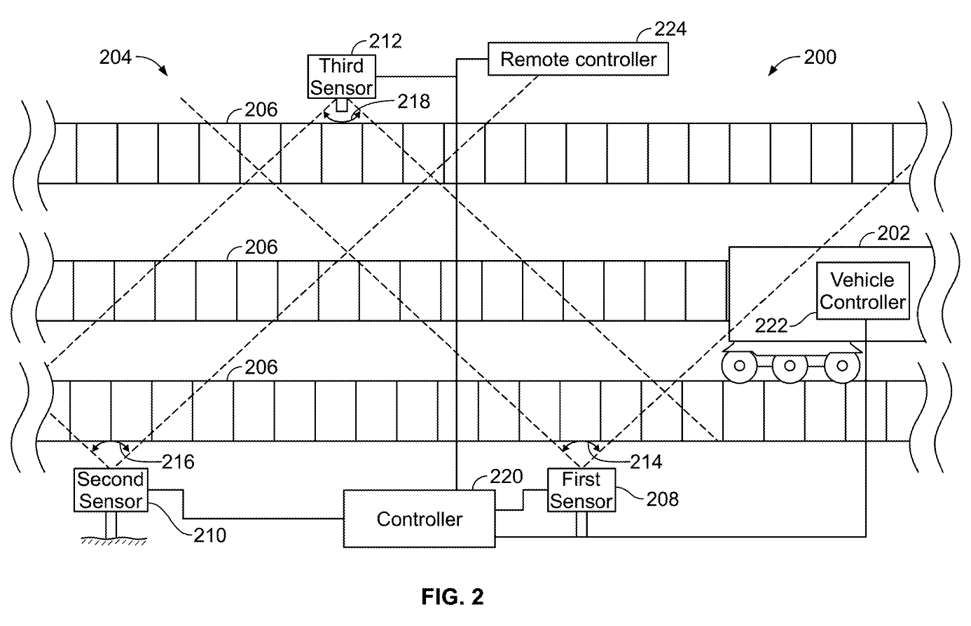

FIG. 2 provides a schematic illustration of a control system 200 utilized to monitor and determine movement of a vehicle system 202 in an area 204. In one example, the vehicle system is the vehicle system described in FIG. 1. The area in one embodiment may be a rail vehicle yard that receives and manages a plurality of rail vehicles. Alternatively, the area may be an airport, harbor, loading dock, automobile dealership, parking garages, parking lot, warehouse, etc., where numerous vehicles or vehicle systems are provided for stopping, loading, unloading, parking, storing, or the like. The area may include one or more routes 206 that may be traversed by the vehicle system 202. The one or more routes may include tracks, railways, roadways, waterways, runways, paths, or the like.

Within the area are a first sensor 208, a second sensor 210, and third sensor 212. While three sensors are illustrated, this is for illustration purposes only. In other embodiments, ten sensors, twenty sensors, or more may be provided for the area. In one example, each sensor is an optical sensor. Such an optical sensor may be a digital camera, infrared camera, etc. The sensor may take still photos, have a continuously operating video feed, etc.

Each sensor has a field of view. In this manner, the first sensor has a first sensor field of view 214, the second sensor has a second sensor field of view 216, and the third sensor has a third sensor field of view 218. Each sensor may also vary its individual field of view. Such variance may be accomplished through movement or rotation of the sensor, including having a static sensor that does not rotate or move and merely always has the same field of view, or a sensor that is able to rotate 360° but does not move otherwise. Alternatively, the sensors may rotate and be able to move otherwise. In another embodiment, the field of view may vary based on functioning within the sensor, such as by changing zoom or magnification of the sensor, an aperture or f-stop of the sensor, etc.

Each sensor may vary the field of view to capture data related to the vehicle system. In one example, movement data may be obtained, while in another example, area data may be obtained. Movement data of the vehicle system may include the location of the vehicle system, change in route of the vehicle system, change in speed of the vehicle system, stopping of the vehicle system, change in direction of the vehicle system, or the like. Area data includes all data related to the area that can be related to the vehicle system. Area data can include movement of another vehicle system, location of a container or cargo, location of other vehicle systems or cars, data related to one or more routes in the area, number of vehicles at a location in the area, or the like. In one example, a first sensor may rotate 45°, while a second sensor adjacent the first sensor may not rotate, but instead move laterally between a first position and a second position. In this manner, when the first sensor is rotated to one direction at 45° and the second sensor is in the first position, no overlap may occur. Meanwhile, when the first sensor is rotated in the same direction 45° and the second sensor is in the second position, an overlap of the field of views may be presented. To this end, when the first sensor is rotated in an opposite direction, and the second sensor is in the second position, no overlap may be presented. So, depending on the movement of each of the first sensor and second sensor, overlapping and non-overlapping field of view may be provided.

In another example, each sensor varies the position and/or field of view of that sensor in response to entry of vehicle system into an area to capture image data of the vehicle system while in the area. Specifically, based on the positioning of each sensor and being able to vary each field of view, an entire area may be monitored by a combination of the sensors. As a result, the sensor field of view of one sensor or of multiple sensors may include two or more routes. In this manner, the sensors may be utilized to determine a route taken by a vehicle system. For example, a field of view of a sensor may extend across or encompass two or more runways, two or more waterways, two or more tracks, two or more roads, two or more paths, etc. such that the sensor can detect the route on which the vehicle system is located, and when a vehicle changes a route. In one example, a rail vehicle may change tracks when in a depot.

The sensors can be coupled (e.g., by wired and/or wireless connections) to a controller 220 that receives movement data, area data, etc., related to the vehicle system from one or more (or all) of the sensors. The movement data and/or area data may be received as part of an image captured by a sensor, a video feed captured by a sensor, etc. Specifically, the sensors communicate data related to vehicle systems in the area being monitored. The controller is also configured to receive location data such as geographic coordinates from a vehicle controller 222 or GNSS receiver onboard the vehicle, so that the controller can make determinations related to the movement of vehicle systems that may or may not be in a field of view of each sensor. Based on the determination of movement of the vehicle systems, the controller may then determine the movement of each of the sensors to increase the amount of movement data that is obtained by each sensor. The controller in one example is a yard controller located within the area and remote from a vehicle system. The yard controller may be operated by a custodian of the yard to facilitate operation of the yard. Alternatively, the controller may be remote from the yard, such as a positive vehicle controller (PVC), back office controller, or the like, that is located at a remote location, such as a dispatch. Still, the controller may be utilized to improve efficiencies in the area based on recorded and communicated movement data provided by the sensors. For example, in an embodiment when the controller is a dispatch controller, movement data may indicate that a vehicle system that was scheduled for maintenance in the area has arrived one hour later than expected. At the stop, in addition to maintenance, the vehicle system is scheduled to switch out cars for hauling cargo. An operator at the controller at the dispatch may then request to know the expected wait time for maintenance and changing of vehicle system cars in the area. Based on the request, sensors located at a maintenance area may detect area data related to the number of vehicles lined up for maintenance, while sensors located at the car changing area may detect area data related to the number of vehicles lined up for car changing. Based on historical data related to the amount of time it takes to provide maintenance to the number of vehicle systems lined up, and the amount of time it takes to change cars based on the number of vehicles lined up, estimates for each may be provided. As such, the operator of the controller may determine that the scheduled maintenance should be skipped, to save time during the stop and get back on schedule because car changing can be quickly done and maintenance cannot.

FIG. 3 provides a schematic illustration of a controller 300 that may be configured to determine movement changes for vehicle systems. In one example, the controller represents the controller in FIG. 2. As such, the controller may be a yard controller, area controller, remote controller, etc.

The controller may be a device that includes one or more processors 302 (microprocessors, integrated circuits, field programmable gate arrays, etc.). The one or more processors may receive location data from a vehicle controller, movement data from one or more sensors, area data from one or more sensors, vehicle characteristics from the vehicle controller and remote controllers, route characteristics from the vehicle controller and remote controllers, trip plans from a vehicle controller and remote controllers, etc. Based on receiving data related to the vehicle system, and in addition, to receiving data related to other vehicle systems that travel within the defined space, the one or more processors make determinations related to the movement of vehicle systems within the defined space.

The controller optionally may also include a controller memory 304, which may be an electronic, computer-readable storage device or medium. The controller memory may be within the housing of the controller or alternatively may be on a separate device that may be communicatively coupled to the controller and the one or more processors therein. By “communicatively coupled,” it is meant that two devices, systems, subsystems, assemblies, modules, components, and the like, are joined by one or more wired or wireless communication links, such as by one or more conductive (e.g., copper) wires, cables, or buses; wireless networks; fiber optic cables, and the like. The controller memory can include a tangible, non-transitory computer-readable storage medium that stores data on a temporary or permanent basis for use by the one or more processors. The memory may include one or more volatile and/or non-volatile memory devices, such as random access memory (RAM), static random access memory (SRAM), dynamic RAM (DRAM), another type of RAM, read only memory (ROM), flash memory, magnetic storage devices (e.g., hard discs, floppy discs, or magnetic tapes), optical discs, and the like. The memory may be utilized to store information related to location data, movement data, historical data, route data, vehicle data etc. The memory may then be used by the one or more processors to access such data for making determinations related to the movement of a vehicle system. In one example, data is logged into a document related to a vehicle system. In another example, data, such as a video feed, may be recorded and stored in the memory for later analysis. In addition, algorithms, applications, models, or the like may also be stored within the memory to be used by the one or more processors in making determinations related to the movement of vehicle systems within the area.

The controller may also include a transceiver 306 configured to communicate with a remote device 308. The transceiver may be a single unit or be a separate receiver and transmitter. In one example, the transceiver may only transmit signals, but alternatively may send (e.g., transmit and/or broadcast) and receive signals. The remote device may be a dispatch controller, a controller of another vehicle, a second controller coupled to the vehicle system, a controller within a wayside device, or the like. In one example, the remote device is a PVC system, and more specifically, in one embodiment a positive train control (PTC) system. The PVC system may be configured to receive speed information from the transceiver, determine and/or calculate the speed of the vehicle system, restrict movement of one or more vehicle systems based on a set of rules, etc. in another example, the remote device may be a vehicle controller that may communicate location data, vehicle data, route data, or the like to the controller.

The controller may also include one or more sensors 310 disposed within and adjacent the area to detect movement data, area data, vehicle data, route data, etc. In one example, each sensor has a determined sensor field of view such that all of the area may be detected by the sensors. In one embodiment, at least one sensor is a camera used to detect the presence and movement of a vehicle system. Adjacent as used herein is next such that a field of view of an area may be obtained. So, any position that allows an area, route, other vehicle, etc. to be within the field of view of a sensor is adjacent to that area, route, other vehicle, etc. even when not on or within that area, route, other vehicle, or the like.

The controller may also include an input device 312 and an output device 314. Specifically, the input device may be an interface between an operator and the one or more processors. The input device may include a display or touch screen, input buttons, ports for receiving memory devices, etc. In this manner, an operator may manually provide parameters into the controller, including vehicle parameters, route parameters, and trip parameters. Similarly, the output device may present information and data to an operator or provide prompts for information and data. The output device may similarly be a display or touch screen. In this manner, a display or touch screen may be an input device and an output device.

The controller can additionally include a vehicle movement regulation unit 316. The vehicle regulation unit may be utilized to determine the movement of a vehicle system while the vehicle system is within the area. Specifically, the vehicle regulation unit receives data related to each vehicle within the area, and previous vehicles within the area. Based on characteristics related to the vehicle systems within the area, and vehicle systems previously in the area, determinations related to the movement of a vehicle system are made.

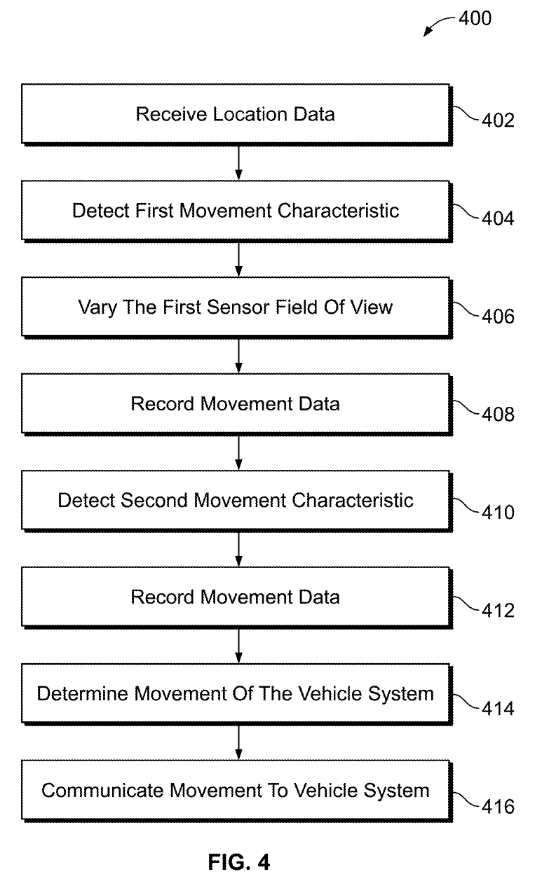

FIG. 4 illustrates a block diagram of a method 400 of controlling movement of a vehicle system in an area. In one example, the control system of FIG. 2 and the controller of FIG. 3 are utilized to implement the method.

At 402, a transceiver of a controller receives location data related to the vehicle system. In one embodiment, the communication may be related to entry of the vehicle system into an area. In one example, the transceiver communicates with a vehicle controller of a vehicle approaching an area. In another example, the transceiver communicates with a remote device such as a dispatch controller, back office controller, or the like of a vehicle system approaching an area. In yet another example, geographic coordinates of the vehicle system are communicated to the controller from a GNSS receiver onboard the vehicle.

At 404, a first movement characteristic of a vehicle system on a first route is detected within a first sensor field of view by a first sensor in response to entry of vehicle system into the area. The first movement characteristic may be a location of the vehicle system, presence on a route, movement direction, movement speed, movement variance, or the like. In one example, the first sensor is a camera that records image data. Specifically, in response to obtaining the communication related to the location data of an incoming vehicle system, the first sensor varies the first sensor field of view to capture the vehicle system as the vehicle system enters the area. In one example, the sensor does not operate until after obtaining the location data. In this manner, battery life of the sensor is extended. In particular, a controller may determine an estimated time in which the vehicle system will be within the first sensor field of view such that the first sensor starts operating in time to vary the field of view to capture the vehicle system as the vehicle system enters the area. In another example, the sensor is continuously operational, and merely varies the first sensor field of view. The first sensor field of view may be varied by moving the sensor from a first position to a second position, rotating the first sensor, zooming in or out, etc.

At 406, the first sensor field of view of the first sensor is varied based on the first movement characteristic detected. In one example, the first sensor rotates as a vehicle system is driving by to follow the vehicle system and capture movement data. In another example, the first sensor zooms out to detect one or more routes to capture movement data of the vehicle system switching routes. In each instance, based on the first movement characteristic detected, one or more processors make determinations related to where the vehicle system is moving to increase the amount of movement data captured by the sensor. In one example, two or more vehicle systems may be in the first sensor field of view. In such an example, the one or more processors may vary movement based on determined prioritizations. For example, the first sensor may vary movement based on the most recent vehicle system to enter the first sensor field of view. Alternatively, variance in the movement of the first sensor may be based on the type of cargo, or if a vehicle system has passengers. In other example, the first sensor may vary movement based on a vehicle system that needs maintenance. In another example, a determination is made to capture as much movement data and/or area data as possible of all vehicle systems in the first sensor field of view. In yet another example, if a second sensor field of view overlaps with a first sensor field of view, such overlap may be taken into consideration such that the first sensor and second sensor operate together to increase the movement data and/or area data obtained by the system.

At 408, movement data and/or area data related to the vehicle system obtained from the first sensor is recorded in a storage device. In one example, the movement data and/or area data is logged into a document, form, or the like. In another example, a series of photos is recorded. Similarly, a video segment may also be recorded. In addition, determinations made by one or more processor regarding the movement of the vehicle system may also be recorded as vehicle data. In this manner, a database is formed of the movement data of all vehicle systems movement in the area. This movement data may then be utilized as historical data when making determinations regarding the movement of the sensors of the system, determinations regarding suggested movements of the vehicle systems in the area, or the like.

At 410, a second movement characteristic of the vehicle system is detected within a second sensor field of view of a second sensor. Similar to the first sensor, the second sensor may rotate as a vehicle system is driving by to follow the vehicle system and capture movement data, and/or area data. In other examples, the second sensor may zoom in or out to detect one or more routes to capture movement data of the vehicle system switching routes. Based on the second movement characteristic detected, one or more processors make determinations related to where the vehicle system is going to move to increase the amount of movement data captured by the sensor. While referred to as a second movement characteristic, the second movement characteristic may be the same as the first movement characteristic, just obtained by the second sensor instead of the first sensor. For example, the first sensor may provide a first movement characteristic related to the location of a vehicle system, and the second sensor may provide a second movement characteristic that is also related to the location of the vehicle system. Additionally, as with the first sensor, two or more vehicle systems may be in the second sensor field of view. The second sensor field of view may overlap with the first sensor field of view, or be separate from the first sensor field of view. Still, one or more processors determine when to vary the movement of the second sensor based on the second sensor field of view and the movement data obtained in that second sensor field of view, including the second movement characteristic. The determination may optionally, also include movement data obtained within the first sensor field of view.

At 412, movement data and/or area data related to the vehicle system obtained from the second sensor is recorded in a storage device. In one example, the movement data is logged into a document, form, or the like. In another example, a series of photos is recorded. Similarly, a video segment may also be recorded. In addition, determinations made by one or more processor regarding the movement of the vehicle system also may be recorded as vehicle data. In this manner, a database is formed of the movement data of all vehicle systems movement in the area. This movement data may then be utilized as historical data when making determinations regarding the movement of the sensors of the system, determinations regarding suggested movements of the vehicle systems in the area, or the like.

At 414, movement of the vehicle system based on movement data and/or area data is determined. In particular, movement of the vehicle system may be based on the first movement characteristic, second movement characteristic, historical movement characteristics of the vehicle system or other vehicle systems, cargo locations, etc. While in this example, only two sensors are provided, in other examples, numerous more sensors may be provided. The historical movement data may include movement data recorded within a controller. Alternatively, the movement data may be received from a remote device such as a PTC controller, back office controller, or the like. The remote device may communicate such historical movement data, including movement characteristics, to the controller to determine movements of a vehicle system. This allows historical information to be used that is gathered from other areas to make determinations. Based on all of the movement characteristics obtained, a determination may be made how to best move the vehicle system through the rest of the area. Route suggestions, maintenance suggestions, cargo or passenger loading suggestions, etc. may be determined based on such information. Such suggestions improve efficiencies of individual vehicle systems while traveling through the area. Such determinations may be made utilizing an algorithm, mathematical function, mathematical model, look up table, decision tree, artificial intelligence algorithm, or the like. By utilizing movement data, including historical movement data, determination may be made to reduce time spent by the vehicle systems in the area, increasing efficiencies.

At 416, a movement determined is communicated to the vehicle system. In particular, a suggested route, maintenance time, loading time, route choice, etc. may be communicated to a vehicle controller. The vehicle controller may then provide an output, such as on a controller screen providing such information for use by an operator. In one example, the vehicle may be automated, resulting in the vehicle system automatically applying the suggested movement communicated. Still, by communicating to an operator, the operator may make a well informed decision to move through the area in an expeditious manner. Additionally, the operator may optionally provide additional input information such as a rescheduling of a delivery, addition of cargo, skipping or rescheduling of maintenance, etc. that may be utilized by the controller to redetermine the movement accordingly. In this manner, movement of each vehicle system is based on as much information as can be gathered, increasing speed through the area.

In one or more embodiments, a control system is provided that may include a first sensor configured to detect a vehicle system. The control system may also include one or more processors in communication with the first sensor. The one or more processors may be configured to receive communication related to entry of the vehicle system into an area, and operate the first sensor to begin monitoring the vehicle system in response to entry of vehicle system into the area. The one or more processors may also be configured to record movement data related to the vehicle system, and determine movement of the vehicle system within the area based on the movement data.

Optionally, the first sensor may have a first sensor field of view, and the one or more processors are also configured to vary the first sensor field of view based on one of entry of the vehicle system into the area, or the movement data. In one aspect, the one or more processors may also be configured to vary the first sensor field of view by moving the first sensor from a first position to a second position. In another aspect, the control system also includes a second sensor configured to detect the vehicle system and having a second sensor field of view that is different than the first sensor field of view. In one example, the one or more processors may also be configured to vary the second sensor field of view based on one of entry of the vehicle system into the area or the movement data.

Optionally, the first sensor may be a static sensor. In one aspect, the one or more processors may also be configured to monitor two or more routes within the area, and wherein the movement data is related to the two or more routes. In another aspect, the first sensor may be a camera. In one example, the communication related to the location data of the vehicle system may be received from a global navigation satellite system receiver of the vehicle system. In one embodiment, the first sensor may be positioned adjacent to a route of the vehicle system. In another embodiment, the one or more processors may also be configured to communicate the movement data related to the vehicle system to a remote device.

In one or more embodiments, a method is provided that may include receiving, at a transceiver, location data related to a vehicle system into an area. The method may also include detecting, within a first sensor field of view of a first sensor, a first movement characteristic of the vehicle system on a first route in response to receiving the location data. The method may also include varying the first sensor field of view of the first sensor based on the first movement characteristic detected, and recording, in a storage device, movement data related to the vehicle system obtained from the first sensor.

Optionally, the method may also include determining, with one or more processors, movement of the vehicle system within the area based on the movement data. The method may also include communicating the movement determined to the vehicle system. In one aspect, the method may also include detecting, within a second sensor field of view of a second sensor, a second movement characteristic of the vehicle system on the first route. In another aspect, the method may also include varying the second sensor field of view based on the first sensor field of view and the first movement characteristic. In one example, the first movement characteristic may be one of presence on a route, movement direction, movement speed, or movement variance. In another example, the method may also include communicating the movement data recorded to a remote device.

In one or more embodiments, a control system is provided and may include a camera configured to detect a vehicle system and two or more routes, and a controller including one or more processors in communication with the camera. The one or more processors may be configured to receive communication related to location data of the vehicle system, and operate the camera to begin monitoring at least one of the vehicle system or the two or more routes in response to receiving the communication related to the location data of the vehicle system. The one or more processors may also be configured to log data related to the vehicle system or the two or more routes, and communicate the data logged related to the vehicle system and the two or more routes.

Optionally, to communicate the data logged, the one or more processors may also be configured to display the data logged on an output of the controller or sending the data logged to a remote device. In one aspect the controller may be a depot controller.

Embodiments of the subject matter described herein relate to a monitoring system and method of operation. The monitoring system may include a camera or other visual data capturing device that may monitor an area within a field of view of the camera. The camera may be communicatively coupled with a control system that receives sensed data captured by the camera. The monitoring system may be used to monitor movement of vehicles, objects, pedestrians, or the like within the field of view of the camera. Optionally, the monitoring system may be used to monitor stationary objects within the field of view of the camera. Prior to monitoring an area with the monitoring system, the monitoring system may need to calibrate or determine one of a position of the camera, or a position of an asset that moves within the field of view of the camera.

In one embodiment, the camera may be installed at a new location. For example, the camera may be relocated to a new location for a new monitoring session, the orientation of the camera may change, or the like. The new geospatial position of the camera may be unknown and is to be determined before the camera may be used to monitor the area. If the position of the camera is unknown, the control system may receive position details of an asset moving within the field of view of the camera. As one example, the asset may be a designated asset vehicle that moves along each of the plural routes the camera is to monitor during the upcoming new monitoring session. The asset may include a marker or visual indicator that indicates to the camera to monitor movement of the asset within the field of view. For example, the marker may be a quick response (QR) code, a bar code, a color block, a shape, or the like. The asset may move along plural routes or within plural regions that the camera is to monitor, and may not move along other routes or within other regions that are not to be monitored. Optionally, the asset may move along plural routes indicating that the routes are allowable routes for movement, and the asset may move along other routes indicating that the other routes are prohibited routes for movement. The position of the camera may be determined based on the details of the area being monitored and the position of the asset moving within the field of view.

In one or more embodiments, the asset may be a vehicle system, such as a rail vehicle, an automobile, a truck, a bus, a mining vehicle, a marine vessel, an aircraft (manned or unmanned, such as a drone), an agricultural vehicle, industrial equipment, or another off-highway vehicle. Suitable rail vehicles may include a locomotive, a switcher, a shunter, or the like. Optionally, the asset and/or vehicle system may be a marine vessel, aircraft, robotic device, or the like, and may be devoid wheels. For example, the asset or vehicle system may move along a waterway, in a flight path, or the like. In one embodiment, the vehicle system is a single vehicle. In other embodiments, the first vehicle system may include two or more vehicles that may travel together. Group movement may be accomplished by vehicles being mechanically coupled together, or by being mechanically separate but logically or virtually coupled and communicating with each other to travel together, such as in a train, convoy, consist, group, swarm, platoon, fleet, or the like. At least one vehicle of the vehicle system may be a propulsion-generating vehicle, and optionally the vehicle system may include one or more non-propulsion generating vehicles.

In another embodiment, the monitoring system may be used to monitor movement of objects within the area being monitored (e.g., active use). For example, the position of the camera may remain the same or unchanged, and the camera may be used to monitor the area for a new monitoring session. If the position or location of the camera is known or understood, then the position of the camera and the details of the area may be used to determine a position of an asset moving within the field of view. For example, the position of the asset may be determined within having access to global positioning information (e.g., GPS data), and may be determined based on the position of the camera, knowledge of viewpoint edges, or other visual indicators within the field of view.

The monitoring system may be used to monitor an area within a field of view of the camera. For example, the monitoring system may monitor one or more routes, regions, pathways, areas, or the like. The monitoring system may be used to monitor stationary and/or transitory objects, vehicles, pedestrians, or the like. As one example, the camera may monitor plural routes of a rail yard within a field of view of the camera. As another example, the monitoring system may monitor an automobile parking lot that includes allowable parking regions and prohibited parking regions. As another example, the monitoring system may monitor aisles of a grocery store, movement of people within the aisles, and placement of objects within or relative to locations of the aisles. As another example, the monitoring system may monitor a marine port, and movement of marine vessels within different regions or waterways of the port. As another example, the monitoring system may monitor a portion of an airport, and monitor passengers, objects, and/or vehicles (e.g., aircraft) within the airport.

While the terms “first,” “second,” and so on, are used herein to indicate different vehicle systems or routes, usage of the term “first” to identify a vehicle system from among several vehicle systems does not mean that the identified vehicle system will always be the first to move (or that the “second” vehicle system will always be the second to move). Instead, unless explicitly stated otherwise, the terms “first,” “second,” and so on, are only used to identify the vehicle systems.

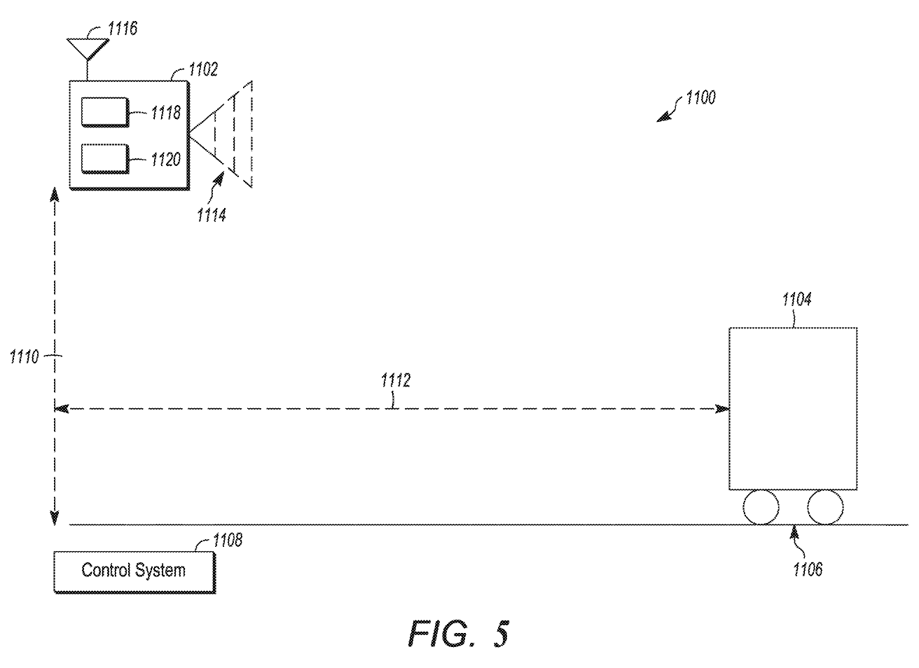

FIG. 5 illustrates one example of a monitoring system 1100 in accordance with one embodiment. The monitoring system may include a monitoring device such as a camera 1102 that may monitor an area within a field of view of the camera. The camera includes an optical lens 1114 that is operably coupled with one or more sensors 1120, such as optical sensors, audio sensors, or the like. The lens and optical sensor(s) obtain visual data of a field of view of the camera (e.g., still images, motion video, or the like). In one or more embodiments, the camera may include an audio sensor and/or audio sensing device such as a microphone or the like (not shown) that may detect or otherwise obtain audio data corresponding to an area around or proximate to the camera. For example, the camera may visually and/or audibly monitor an area within the field of view of the camera.

The camera may include a controller 1118. The controller may represent a control module that can include one or more processors, microcontrollers, or other logic-based devices and/or associated software or instructions, for carrying out one or more operations described herein.

The camera includes a communication system 1116 that represents transceiving circuitry, one or more antennas, modems, or the like, that may be setup for one or both of wired or wireless communication. The communication system may communication with components or systems, such as, but not limited to, a control system 1108, a vehicle system 1104, a wayside device (not shown) disposed along a route 1106, cloud storage devices or systems, or the like. In one or more embodiments, the communication system may receive and/or provide data signals, such as sensed data signals, to the control system, to the vehicle system, or the like.

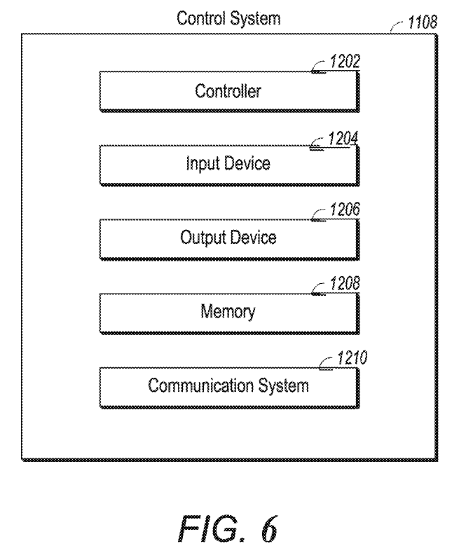

The monitoring system includes a control system 1108. In the illustrated embodiment, the control system is disposed off-board or separate from the camera and the vehicle system, but optionally may be disposed onboard or coupled with the camera and/or the vehicle system. FIG. 6 illustrates a schematic of the control system in accordance with one embodiment. The control system may represent a control module, and can include a controller 1202 that can include one or more processors, microcontrollers, or other logic-based devices and/or associated software or instructions, for carrying out one or more operations described herein.

The control system may be manually operated by receiving instruction signals from an input device 1204 e.g., a device that receives input from an operator such as, but not limited to, a touchscreen, a joystick, a keyboard, a switch, a wheel, a microphone, or the like) based on manually input from an operator at the input device. An output device 1206 can provide information to the operator, such as data received from the camera (e.g. visual and/or audio sensed data), information associated with the camera (e.g., battery life remaining, camera memory storage capacity, a position of the camera, a direction the camera lens is facing, a field of view of the camera, or the like), information associated with objects, vehicles, pedestrians, or the like, being monitored by the monitoring system, or the like. The control system may include a memory 208 or other data storage device. Optionally, the control system may be communicably coupled with other storage databases (e.g., other memory devices of other systems, data storage cloud systems, or the like).

The control system includes a communication system 1210 that may be setup for one or both of wired or wireless communication. For example, the communication system can represent transceiving circuitry, one or more antennas, modems, communication cables, or the like. The communication system may communication (e.g., receive and/or provide data signals) with a controller onboard one or more vehicle systems, the controller of the camera, a controller of another off-board controller, controllers of one or more wayside devices (not shown), with one or more traffic control devices (e.g., traffic lights, barriers, rail crossing gates, or the like), one or more objects within or outside of a field of view of the camera, one or more additional cameras monitoring other areas, or the like.

In one embodiment, the communication system can interact with other systems via one or more communication types. Suitable communication types can include, but are not limited to, cellular networks (e.g., the Global System for Mobile Communications (GSM)), mesh networks using Ethernet standards, wireless communication protocols (e.g., Bluetooth), radio and shortwave communication types, or the like. In one or more embodiments, where two or more communication types are present, the communication system may translate some or all of a data stream from one type to another. Similarly, different data protocols may be used. Such translation may allow the communication system to act as a transference point for data transmission. The translation may allow for different types of equipment (e.g., first and second vehicle systems may each use communication types different from each other to communicate with each other via the communication system). The communication system may switch types, protocols, and/or communication pathways in response to delegation of signal or failure of one pathway. This may provide redundancy of communication by the communication system. In one embodiment, the communication system may decrypt, decompile, or disaggregate information, parse information, and send along all or part of a message (e.g., alone or combined with new data, or with encryption, or both). The communication system may be the same as or similar to other communication devices or communication systems described herein.

In one or more embodiments, the control system may represent a back-office server or a dispatch center, such as of a positive vehicle control (PVC) system. A PVC system is a control system in which a vehicle is allowed to move, and/or is allowed to move outside a designated restricted manner (such as above a designated penalty speed limit), only responsive to receipt or continued receipt of one or more signals (e.g., received from off-board the vehicle system) that meet designated criteria, the signals have designated characteristics (e.g., a designated waveform and/or content) and/or are received at designated times (or according to other designated time criteria) and/or under designated conditions. This is opposed to ‘negative’ vehicle control systems where a vehicle system is allowed to move unless a signal (restricting movement) is received. The back-office server may be a vital or a non-vital system such that data stored, contained, maintained, communicated between, or the like, may be vital (e.g., protected) and/or non-vital (e.g., non-protected) data. Alternatively, the off-board control system represents another computerized system that communicates with vehicles and/or vehicle systems described herein.

Returning to FIG. 5, the camera monitors the vehicle 1104 that moves along the route 1106. In the illustrated embodiment, the vehicle is a propulsion-generating vehicle that includes wheels that move the vehicle along the route. The vehicle may be a rail vehicle system (e.g., locomotive, transit vehicle, rail car, etc.), an automobile, a truck, a bus, a mining vehicle, agricultural equipment, another off-highway vehicle, or the like, that includes wheels to move along the route. Optionally, the vehicle system may be devoid wheels, such as a marine vessel, an aircraft (manned or unmanned), or the like, which may move along waterways and flightpaths, respectively. In one or more embodiment, the vehicle system may include two or more vehicles that travel together along a route, such as a consist convoy, or the like. At least one of the vehicles may be a propulsion-generating vehicle, and one or more other vehicles optionally may be non-propulsion generating vehicles. As one example, the vehicle system may be a train consist that includes a propulsion-generating locomotive and plural rail cars that move together along a rail track. As another example, the convoy may include a tug or tugboat (e.g., propulsion generating marine vessel) operably coupled with a non-propulsion-generating barge that move together along a waterway.

In order for the camera to understand what routes, regions, pathways, area, or the like, that the camera is to monitor, the camera needs information associated with the area that is to be monitored, a position of the camera (e.g., a position relative to a position or location of routes, regions, pathways, areas, of the like, to be monitored), and information associated with an asset, object, person, or the like, that is to be monitored.

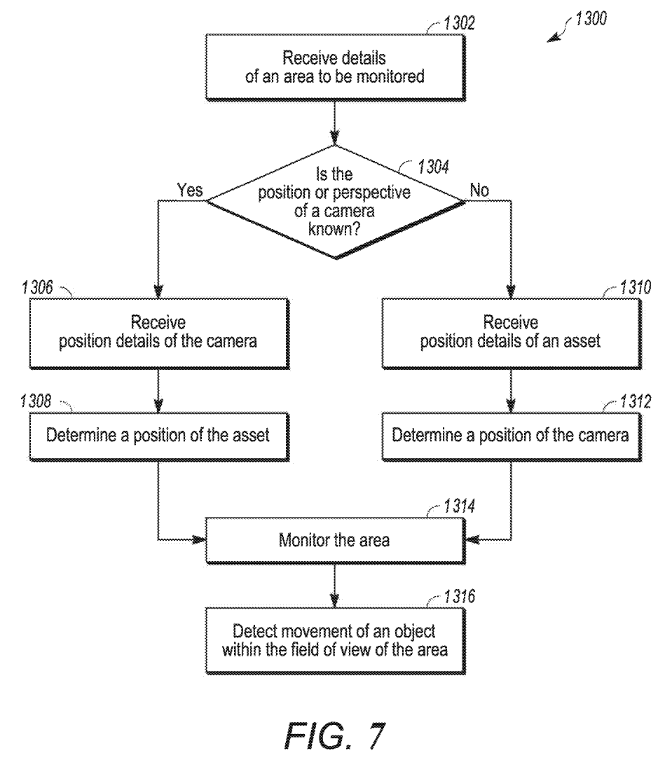

FIG. 7 illustrates a flowchart 1300 of one example of a method of monitoring an area in accordance with one embodiment. The steps of the method may be completed by the monitoring system shown in FIG. 5. The area that is to be monitored may be a new area to be monitored. For example, the camera may have previously been monitoring one area, and may be moved (e.g., rotated, displaced, repositioned, or the like) by an operator of the monitoring system to monitor a different area. Optionally, the area to be monitored may be the same, but the objects, assets, routes, regions, pathways, or the like, may be different. For example, the camera may be obtaining visual sensor data associated with vehicles that move along a first route during a first monitoring session, and may obtain visual and audio sensor data associated with vehicles that move along a different, second route during a second, new monitoring session.

At step 1302, one or both of the controller of the off-board control system or the controller of the camera, may receive details of an area that is to be monitored. The position details of the area that is to be monitored may include topographical details, route zone details, an indication of regions where positioning, movement, or the like, of objects and/or vehicles is allowed, an indication of regions where positioning, movement, or the like, of objects and/or vehicles is prohibited, or the like. In one or more embodiments, the position details of the area may include speed limits, vehicle restrictions, vehicle allowance, or the like, associated with one or more pathways, routes, regions, or the like, disposed within the area to be monitored. In one or more embodiments, the details of the area may include historical details associated with the area, such as historical data associated with a number and/or type of different vehicles that moved along one or more routes within the area, historical data associated with routes, pathways, and/or regions receiving maintenance and/or repairs (e.g., repaving of paved routes, repainting of vehicle and/or pedestrian pathway lines and/or lanes, or the like). Optionally, the details of the area may include environmental information (e.g., ambient temperature, humidity, or the like), geographical information (e.g., geographic latitude and longitudinal coordinates), or the like.

At step 1304, a determination is made whether the position and/or perspective of the camera is known. For example, if the camera has been moved (e.g., pivoted, relocated, installed, changed from a first position to a second position, or the like) from a first location to a second location, the position and/or perspective of the camera may be unknown, and the camera may need to be calibrated to understand the location of the camera relative to the area to be monitored. Alternatively, if the camera has not been moved, but is being used to monitor a new monitoring area within the field of view of the camera, if the camera is to focus on new details (e.g., objects, vehicles, pedestrians, or the like) within the same field of view of the camera, the camera does not need to be calibrated or recalibrated, or the like, the position and perspective of the camera may be known. For example, the position, orientation, perspective, location, or the like, of the camera may be known from a prior monitoring session, and may not be needed for a new monitoring session where the position and/location of the camera is not moved between the prior and new monitoring sessions.

The position, location, and/or the perspective of the camera may be known if the off-board control system and/or the controller of the camera know or have information associated with a geospatial location of the camera. For example, returning to FIG. 5, the position and/or location of the camera may be known if the control system and/or the controller of the camera know or are able to access details associated with an elevation distance 1110 the camera is positioned, such as above the route, a horizontal or longitudinal distance 1112 between a portion of the camera and the vehicle, or the like. Optionally, the location and/or position may be known if the control system and/or the controller of the camera have details associated with the geographic coordinates.

If the camera is calibrated such that one of the position, location, and/or perspective of the camera is known, flow of the method proceeds toward step 1306. At step 1306, responsive to determining that the position, perspective, and/or location of the camera is known, the off-board control system and/or the controller of the camera may receive the position details of the camera (e.g., elevation distance above sea level, above the route, above the area to be monitored, longitudinal distance away from a route, region, pathway, or the like, to be monitored, or the like). In one embodiment, the controlled of the camera may receive the position details of the camera from the off-board control system. In another embodiment, the control system and/or the controller of the camera may receive the position details of the camera from another database accessible by the control system and/or controller, respectively.

At step 1308, a position of an asset moving within a field of view of the camera may be determined responsive to receiving the position details of the camera. In one or more embodiments, the asset may be a vehicle, object, pedestrian, or the like. The position of the asset may be determined based on the position details of the camera, the details of the area that is being monitored, or the like. For example, the position of the asset may be determined without having geospatial or other positioning information of the asset. The real position of the asset may be determined from knowing viewpoint edges of the field of view of the camera, knowing locations of other visual indicators within the field of view, or the like. In one or more embodiments, the visual indicators may be a pole, a building, another object that has remained stationary between the prior and new monitoring sessions, or the like.

Alternatively, if the camera is not calibrated and the position or perspective of the camera is unknown, flow of the method proceeds from step 1304 toward step 1310. For example, the camera may need to be calibrated to understand the location, position, and perspective of the camera relative to the area to be monitored before the camera may be used to monitor an area. In one or more embodiments, the camera may be calibrated to be used to monitor an area based on details of the area and details of a position of an asset that moves within the field of view of the camera.

At step 1310, the control system and/or the controller of the camera may receive position details of the asset. The position details may include a geospatial location, topographical information of routes, pathways, or regions along which mobile assets are moving, or the like. In one or more embodiment, the position details may be received from a global positioning system (GPS) onboard and/or coupled with the asset. Optionally, the position details may be received from a wayside device that detects movement of the asset.

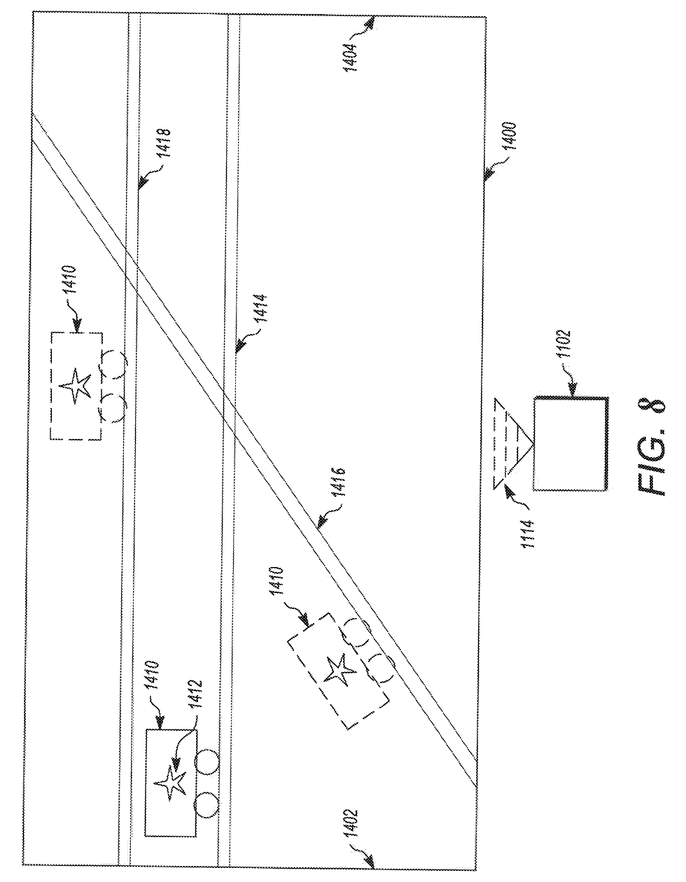

In one or more embodiments, an asset may move within the field of view of the camera along a route that the camera is to monitor during a monitoring session. For example, FIG. 8 illustrates a schematic of one example for receiving position details of an asset 1410 in accordance with one embodiment. In the illustrated embodiment, the asset is a vehicle that moves within a field of view 1400 of the camera. The field of view is defined by a first defining mark 1402 and a second defining mark 1404. In the illustrated embodiment, the first and second defining marks are first and second edges, respectively, of the field of view of the camera. Optionally, the first and second defining marks may be objects and/or predefined locations within the field of view. The camera may detect or capture image data of the asset by monitoring movement of the asset within the field of view relative to the first and second defining marks.

The asset may include a marker 1412, visual indicator, or the like, that the visual sensor of the camera may detect. For example, the marker may be a quick response (QR) code displayed on an exterior surface of the asset that the camera may detect. As another example, the marker may be another bar code, a color block, or the like, displayed on a side of the asset as the asset moves within the field of view. In the illustrated embodiment, the marker is a star shape that is displayed on an exterior surface of the asset.

The camera may identify the asset as an asset to monitor (e.g., based on the marker or visual indicator), and may monitor the asset as the asset moves in one or more directions in the field of view of the camera. In one or more embodiments, the asset may move along a pathway, a route, or the like, that indicate to the controller of the camera which pathways, routes, or the like, the camera is to monitor during an upcoming monitoring session. For example, the asset may move along a first route 1414 within the field of view of the camera, may subsequently move along a second route 1416 within the field of view, and may subsequently move along a third route 1418. The first, second, and third routes may be routes or pathways that the camera is to monitor during an upcoming monitoring session.

In one or more embodiments, one or more of the first, second, and third routes may be identified as routes that objects or vehicles may be allowed or permitted to move along during the upcoming monitoring session. Optionally, the asset may move along a prohibited pathway, prohibited route, or the like, to inform the controller of the camera which pathways and routes vehicles, objects, and pedestrians are not allowed to move during the upcoming monitoring session. For example, one of the first, second, or third routes may be identified as routes that vehicles and objects may be prohibited from moving along during the upcoming monitoring session.

Returning to FIG. 7, at step 1312, the control system and/or the controller of the camera may determine a position of the camera based on the position details of the asset and the details of the area to be monitored. In one or more embodiments, the position of the camera may be determined (e.g., the camera may be calibrated) based on a combination of two or more of the details of the area to be monitored, the visual sensor data indicative of movement of the asset within the field of view (e.g., movement of the asset within the field of view along at least one of plural paths), and the known position details (e.g., GPS position details) of the asset as the asset moved within the field of view.

At step 1314, the area is monitored during a monitoring session. The camera may understand which routes, pathways, regions, or the like, the camera is to monitor during the monitoring session, and may monitor movement or positioning of vehicles, objects, pedestrians, or the like, within or along the routes, pathways, regions being monitored. For example, the camera may ignore vehicles or objects moving along routes or pathways that are not being monitored. Optionally, the camera may understand which types of vehicles, types of objects, or the like, the camera is to monitor during the monitoring session, and may monitor the specified types of vehicles and objects during the monitoring session and may ignore other types of vehicles and objects.

At step 1316, the camera may detect movement, placement, or positioning, of vehicles, objects, or the like, within the field of view of the camera in the area being monitored. For example, the camera may monitor vehicles that move along one route, and may wirelessly communicate the sensed visual data to the control system. In one embodiment, the communication system of the camera may communicate the sensed data at a predefined increment of time (e.g., once every hour, once every 24 hours, once every week) or responsive to predefined events occurring (e.g., a predefined number of vehicles have moved along the route, a prohibited vehicle has moved along the route being monitored, a vehicle has moved along a prohibited route, or the like).

In one or more embodiments, the control system may receive the sensed data from the camera and may analyze the data to determine one or more characteristics of the area being monitored. For example, the control system may determine that an amount of level of congestion of vehicle traffic has increased over a predetermined amount of time. As another example, the control system may determine a length of time that an object has remained positioned at a location within the field of view. As another example, the control system may determine a number of times that a vehicle system has moved into and/or out of the field of view, and/or a speed at which the vehicle system moves each time the vehicle system moves into and/or out of the field of view. As another example, the control system may determine a speed at which vehicles, objects, or pedestrians move along one route, and a speed at which other vehicles, objects, or pedestrians move along another route or pathway. As another example, the control system may determine a frequency at which vehicles or objects move along a first route, and a frequency at which vehicles or objects move along a second route. Optionally, the sensed data may be used in any alternative manner by the control system to understand the field of view of the area being monitored. In one or more embodiments, the sensed data of a first monitoring session may be compared with sensed data of a second monitoring session.

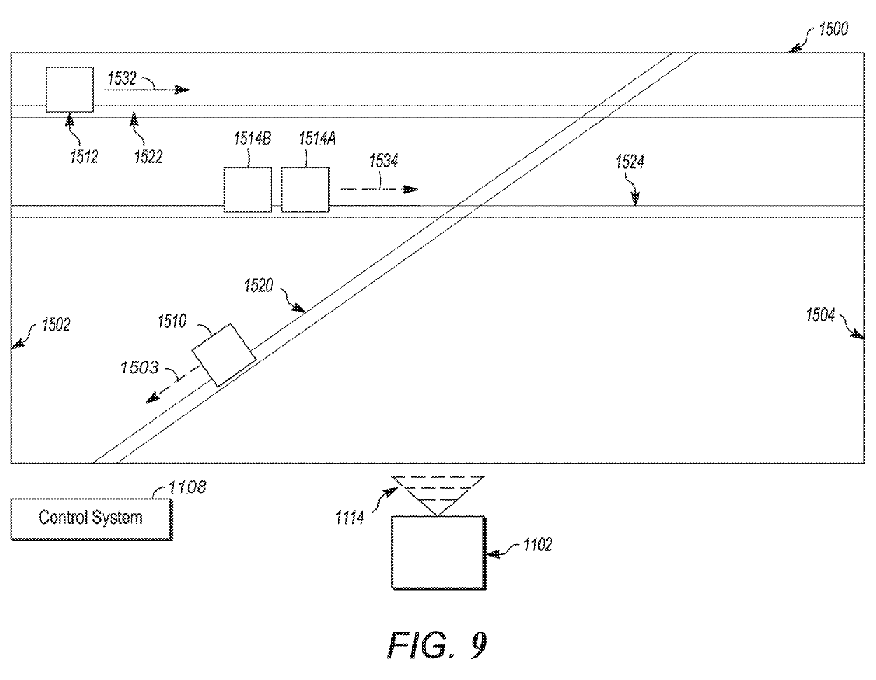

An area may be monitored responsive to determining one of the position of the camera or the position of the asset. FIG. 9 illustrates one example of monitoring an area with a monitoring system in accordance with one embodiment. The lens of the camera may be positioned, oriented, and sized to capture a field of view 1500 of the area to be monitored. The area to be monitored within the field of view may be defined by a first defining mark 1502 (e.g., a first edge of the field of view) and a second defining mark 1504 (e.g., a second edge of the field of view).

In the illustrated embodiment, plural different vehicles move along plural routes, and the camera may monitor movement of vehicles and/or objects along each of the plural routes. For example, a first vehicle system 1510 moves in a first direction 1530 along a first route 1520, a second vehicle system 1512 moves in a second direction 1532 along a second route 1522, and a third vehicle system 1514 moves in a third direction 1534 along a third route 1524. The third vehicle system includes first and second vehicles 1514A, 1514B that move together (e.g., mechanically and/or logically) along the third route.

The control system may receive sensed data (e.g., visual data, audio data, or the like) from the camera. In one embodiment, the control system may receive details of the first vehicle system moving along the first route, and may determine that the first vehicle system is prohibited from moving along the first route. Optionally, the control system may determine that the first vehicle system is allowed to move along the first route, but is prohibited from moving in the first direction along the first route. The control system may automatically wirelessly communicate an alert to the first vehicle system directing the first vehicle system to move to a different route, to change a direction of movement, or the like. In one or more embodiments, a controller of the first vehicle system (not shown) may automatically change operating settings based on the alert communicated by the control system. Optionally, the control system may remotely control operation of the first vehicle system to remotely change an operating setting of the first vehicle system (e.g., to change a direction of movement of the first vehicle system, to slow or stop movement of the first vehicle system, or the like).

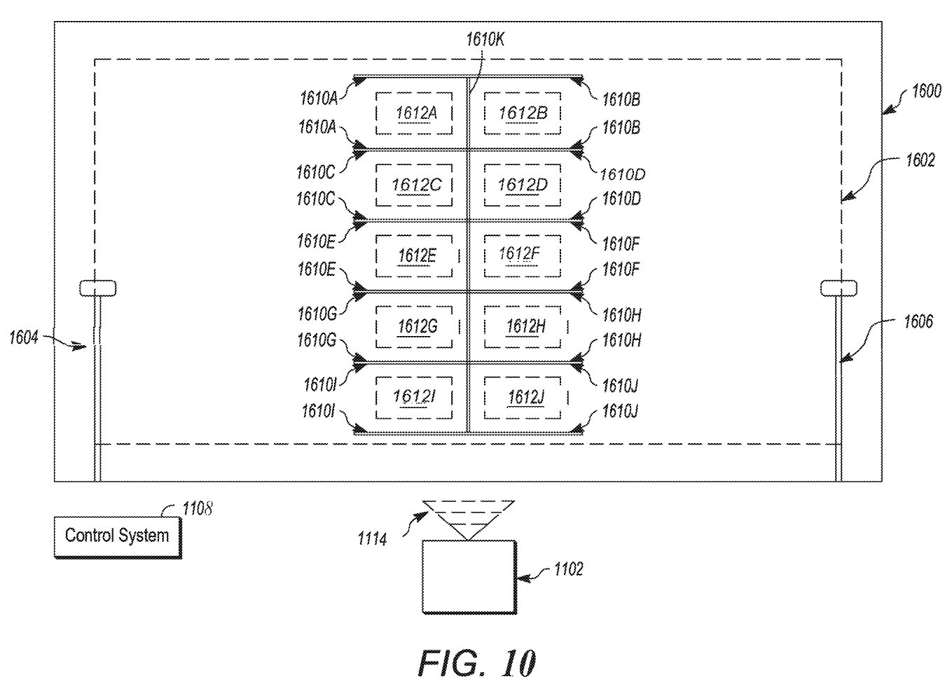

FIG. 10 illustrates another example of monitoring an area with a monitoring system in accordance with one embodiment. The control system may have received the details of an area 1602 within a field of view 1600 to be monitored and may have determined one of a position of the camera or a position of an asset moving within the field of view. In the illustrated embodiment, the area to be monitored is smaller than the field of view of the camera lens. The area to be monitored is defined by a first defining marker 1604 and a second defining marker 1606. In the illustrated embodiment, the first and second defining markers are objects within the field of view of the camera. The field of view may include a parking lot or parking area where vehicles may pull into and out of to park, and the defining markers may be light poles within the parking lot.

The area to be monitored includes plural prohibited pathways 1610A-K that may represent the parking lanes defining parking spaces. The area includes plural parking regions 1612A-J that are defined by the prohibited pathways and may indicate allowable regions or areas where vehicles or objects may move into or out of, or may be positioned (e.g., parked). The camera may monitor the area and communicate the sensed data to the control system. The control system may determine that a vehicle is parked or positioned along or across one of the prohibited pathways and may communicate an alert to an owner of the parking lot. Optionally, the control system may communicate an alert to a towing company indicating that the vehicle parked or positioned across one of the prohibited pathways needs to be removed.

FIG. 11 illustrates one example of monitoring a first area 1702 with the camera of the monitoring system in a first position 1716 in accordance with one embodiment. A field of view 1700 of the camera may include the first area to be monitored and a second area 1704. The camera may monitor plural routes and movement of objects or vehicles within the first area along the plural routes and may ignore movement of objects or vehicles within the second area during a monitoring session. For example, the camera may monitor a first route 1706 and a portion of a second route 1708 that extends within the first area and may ignore another portion of the second route that extends within the second area and a third route 1710. The camera may monitor movement of a first vehicle system 1720 but may ignore movement of second and third vehicle systems 1722, 1724, respectively, that move in the second area. Optionally, the camera may begin to monitor movement of the second vehicle system responsive to the second vehicle system moving along the second route and into the first area being monitored.

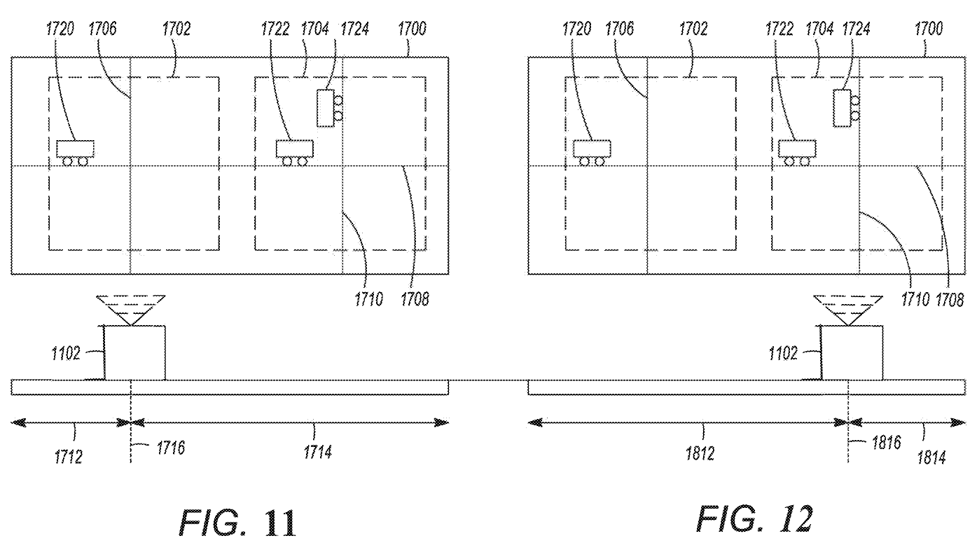

The first position of the camera is defined by a first distance 1712 away from a first edge of the field of view of the camera, and a second distance 1714 away from a second edge of the field of view of the camera. Optionally, the position of the camera may move from the first position 1716 to a second position. For example, FIG. 12 illustrates one example of monitoring the second area with the camera in a second position 1816. The position of the camera may need to be calibrated responsive to moving the camera from the first position to the second position. For example, the steps 1310 and 1312 shown in the flowchart illustrated in FIG. 7 may be repeated based on the camera moving from the first position to the second position. For example, the controller of the camera and/or the control system may receive position details of an asset moving within the field of view responsive to changing the position of the camera from the first position to the second position.

The camera positioned in the second position may monitor the second area of the field of view and may ignore the first area. For example, the camera may monitor a portion of the second route 1708 and the third route 1710 and may ignore the first route 1706 while the camera monitors movement within the second area. The camera may monitor movement of the second vehicle system 1722 and movement of the third vehicle system 1724 as the second and third vehicle systems move within the second area and may ignore movement of the first vehicle system 1720 that moves within the first area. Optionally, the camera may begin to ignore movement of the second vehicle system responsive to the second vehicle system moving along the second route out of the second area and toward the first area.

The second position of the camera is defined by a first distance 1812 away from a first edge of the field of view of the camera, and a second distance 1814 away from a second edge of the field of view of the camera. For example, the camera in the first position shown in FIG. 11 is closer to the first edge of the field of view relative to the camera in the second position shown in FIG. 12. Additionally, the camera in the first position shown in FIG. 11 is further from the second edge of the field of view relative to the camera in the second position shown in FIG. 12.

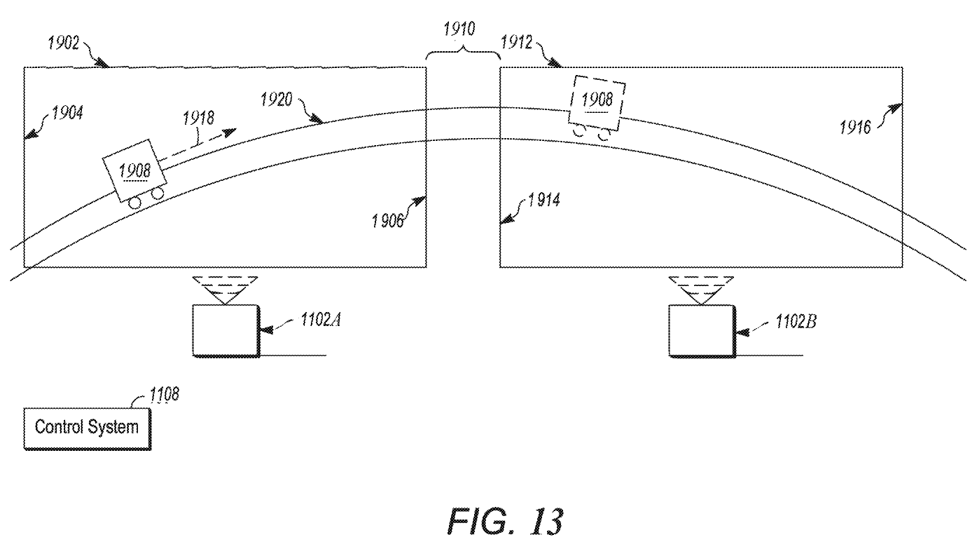

FIG. 13 illustrates a monitoring system that monitors plural different areas in accordance with one or more embodiments. The monitoring system includes the control system that is communicatively coupled with a first camera 1102A and a second camera 1102B. The first camera may monitor a first area 1902 defined by first and second defining marks 1904, 1906, and the second camera may monitor a second area 1912 defined by first and second defining marks 1914, 1916. The first and second areas to be monitored includes at least one route 1920 that extends between the first and second areas. For example, a portion of the route is disposed within the first area being monitored by the first camera, and another portion of the route is disposed within the second area being monitored by the second camera.

In the illustrated embodiment, a vehicle system 1908 moves along the route in a direction 1918. For example, the vehicle system is disposed within the first area that is monitored by the first camera, and is moving in a direction along the route toward the second area that is monitored by the second camera. In one or more embodiments, the control system may receive sensed data from the first and second cameras. For example, the control system may receive sensed data from the first camera indicating when the vehicle system has moved out of the first area, and may receive sensed data from the second camera indicating when the vehicle system has moved into the second area as the vehicle system moves along the route.

In one or more embodiments, the control system may use the received sensed data to determine a moving speed of the vehicle system, a change in speed of the vehicle system, or the like. Optionally, the control system may be anticipating the vehicle system to enter into the second area at a predetermined time, and may determine that the vehicle system entered into the second area at a time greater than or less than the predetermined time. Optionally, the control system may be anticipating the vehicle system to enter into the second area, and may communicate an alert to the vehicle system responsive to determining that the vehicle system has not entered into the second area. For example, the vehicle system may have experienced a failure or other issue causing the vehicle system to stop before reaching the second area.

In one or more embodiments, the control system may virtually track movement of the vehicle system while the vehicle system moves in a gap area 1910 between the first and second areas. For example, the control system may determine the virtual location of the vehicle system based on the last known trajectory of the vehicle system while the vehicle system was moving in the first area, and calculate an expected time of entry of the vehicle system into the second area based on the trajectory. The control system may communicate an alarm responsive to the vehicle system not entering into the second area by the expected time of entry, or at a time that is after or later than the expected time of entry.

In one or more embodiments, the control system may receive sensed data from plural different cameras. The cameras may be positioned such that the cameras provide panoramic or three-dimensional visual data of an area to be monitored. For example, visual data of one camera may be stitched together (or otherwise coupled with) with visual data of an adjacent camera to form a combined image based on the visual data obtained from the two cameras.

In one embodiment, the control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In one or more embodiments, the processors may be initially trained to determine a position of the camera, the position of the asset moving within the field of view of the camera, or the like. Overtime, after a predetermined amount or length of usage, after a predetermined amount of data and/or other information has been obtained, or the like, the processors may be taught, the training may be revised, or the like, over time. The processors may be taught and/or retrained in policies, on expected observations of the field of view, on expected behaviors of objects or assets within the field of view, or the like, using one or more of machine learning, artificial intelligence, or the like.

In accordance with one example or aspect, a method may include receiving details of an area to be monitored, and receiving one of a) position details of an asset moving within a field of view of the area to be monitored, or b) position details of a camera configured to monitor the area. The method may include determining one of c) a position of the camera responsive to receiving the position details of the asset moving within the field of view of the area; or d) a position of the asset moving within the field of view responsive to receiving the position details of the camera.

Optionally, determining the position of the camera may include identifying a first defining mark and a second defining mark of the field of view of the area. Optionally, the first defining mark may be one or more of a first edge of the field of view of the camera, a first object within the field of view of the camera, or a first location within the field of view of the camera. Optionally, the second defining mark may be one or more of a second edge of the field of view of the camera, a second object within the field of view of the camera, or a second location within the field of view of the camera. Optionally, the method may include detecting movement of the asset within the field of view relative to the first and second defining marks. Optionally, determining the position of the camera may include monitoring movement of the asset within the field of view along at least one of plural paths. Optionally, the method may include monitoring the area, and detecting movement of one or more objects within the field of view of the area. Optionally, the method may include determining that at least one of the one or more objects is moving within the area one or more of along a prohibited pathway or within a prohibited region, and communicating an alert responsive to the at least one object moving one or more of along the prohibited pathway or within the prohibited region. Optionally, the method may include receiving the position details of the camera configured to monitor the area responsive to starting a new monitoring session. Optionally, the method may include receiving the position details of the asset moving within a field of view of the area to be monitored responsive to changing a position of the camera from a first position to a second position. Optionally, the camera may be in a first position to monitor the area, and the camera may be in the second position to monitor a different area. Optionally, the position details of the area may include one or more of topographical details, route zones, allowed regions, or prohibited regions.

In accordance with one example or aspect, a monitoring system may include a camera to monitor a first area, and a controller comprising one or more processors. The controller may receive sensed data from the camera. The processors may include details of the first area to be monitored. The processors may receive one of a) position details of an asset moving within a field of view of the first area to be monitored, or b) position details of a camera configured to monitor the first area. The processors may determine one of c) a position of the camera responsive to receiving the position details of the asset moving within the field of view of the first area, or d) a position of the asset moving within the field of view responsive to receiving the position details of the camera.

Optionally, the one or more processors may identify a first defining mark and a second defining mark of the field of view of the first area. Optionally, the first defining mark may be one or more of a first edge of the field of view, a first object within the field of view, or a first location within the field of view, and the second defining mark may be one or more of a second edge of the field of view, a second object within the field of view, or a second location within the field of view. Optionally, the camera may detect movement of the asset within the field of view relative to the first and second defining marks. Optionally, the one or more processors may determine the position of the camera responsive to the camera monitoring movement of the asset within the field of view along at least one of plural paths. Optionally, the camera may detect movement of one or more objects within the field of view of the first area. Optionally, the one or more processors may determine that at least one of the one or more objects moving within the first area one or more of along a prohibited pathway or within a prohibited region, and may communicate an alert responsive to the at least one object moving the one or more of along the prohibited pathway or within the prohibited region.

In accordance with one example or aspect, a method may include receiving one of a) position details of an asset moving within a field of view of an area to be monitored, or b) position details of a camera configured to monitor the area. The method may include determining one of c) a position of the camera responsive to receiving the position details of the asset moving within the field of view, or d) a position of the asset moving within the field of view responsive to receiving the position details of the camera. The method may include monitoring the area, detecting movement of one or more objects within the field of view of the area with the camera, determining that at least one of the one or more objects moving within the area one or more of along a prohibited pathway or within a prohibited region, and communicating an alert responsive to the at least one object moving one or more of along the prohibited pathway or within the prohibited region.

In one embodiment, a monitoring system identifies vehicle systems within a yard. The monitoring system includes one or more cameras and one or more processors. The one or more cameras is positioned at the yard and each has a field of view that includes at least a portion of one or more routes within the yard, as shown in FIGS. 2, 8, 9, 11, 12, and 13. The one or more cameras captures image data of vehicle systems within the field of view. The one or more processors receives the image data captured by the one or more cameras. The one or more processors further detects, in the image data, identification devices positioned on exterior surfaces of the vehicle systems within the yard, as shown in FIG. 8. The one or more processors further identifies the vehicle systems the yard based on the detected identification devices.

In one embodiment, in the monitoring system, the one or more processors further extracts identification data from the identification devices detected in the image data. The identification data corresponds to a unique identity of a respective vehicle system. The one or more processors further identifies the vehicle systems within the yard by using the extracted identification data.

In one embodiment, in the monitoring system, the identification devices include markers or visual indicators positioned on the exterior surfaces of the vehicle systems, as shown in FIG. 8. The one or more processors further identifies the vehicle systems within the yard by identifying a respective vehicle system as an asset to be monitored based on detecting a respective one of the markers or visual indicators in the image data.

In one embodiment, in the monitoring system, the markers or visual indicators include at least one of a QR code, a bar code, a color block, or a shape.

In one embodiment, in the monitoring system, the one or more processors further analyzes the image data received from the one or more cameras to determine a count metric for the yard, and the count metric is associated with the vehicle systems identified in the field of view of the one or more cameras. For instance, the count metric is associated with the number of the vehicle systems identified in the field of view of the one or more cameras.

In one embodiment, in the monitoring system, the one or more processors further detects vehicle line up information associated with the vehicle systems based on the image data received from the one or more cameras.

In one embodiment, the monitoring system further includes two or more cameras configured to capture the image data of the vehicle systems from two opposite sides of the one or more routes, for instance, as shown in FIG. 2, or from the same side of the one or more routes, for instance, as shown in FIGS. 2 and 13.

In one embodiment, the monitoring system further includes a first camera with a first field of view and a second camera with a second field of view different than the first field of view, as shown in FIGS. 2 and 13. In one embodiment, in the monitoring system, the one or more processors further combines the image data from the first camera and the image data from the second camera in real time.

In one embodiment, the monitoring system further includes a first camera with a first field of view directed toward an entry zone of a yard, as shown in FIG. 2, and a second camera with a second field of view directed toward a switching zone within the yard, as shown in FIGS. 8 and 9.

In one embodiment, in the monitoring system, the vehicle systems include a container or a cargo 2110 and a vehicle 2118 carrying the container or the cargo, as shown in FIG. 1.

In one embodiment, a monitoring system includes identification devices and one or more processors. The dentification devices each determines unique identity data of a plurality of vehicle systems along one or more routes. The one or more processors receives the determined identity data of the plurality of vehicle systems from the identification devices and then identifies the plurality of vehicle systems along the one or more routes based on the received identity data of the plurality of vehicle systems.

In one embodiment, in the monitoring system, the identification devices comprise one or more of a marker, a visual indicator, a QR (Quick Response) code, a bar code, a color block, or a shape.

In one embodiment, in the monitoring system, the one or more processors further identifies the plurality of vehicle systems along the one or more routes in at least one of a vehicle entry zone or a vehicle switching zone based on the received identity data of the plurality of the vehicle systems.

In one embodiment, in the monitoring system, the one or more processors further determines one or more of line-up information or counting information or movement information of the plurality of vehicle systems along the one or more routes based on the received identity data of the plurality of vehicle systems.

In one embodiment, in the monitoring system, the identification devices further operate in at least one of a low light environment, a continuous time period, or all weather conditions.

In one embodiment, in the monitoring system, the plurality of vehicle systems include a container or a cargo and a vehicle carrying the container or the cargo.

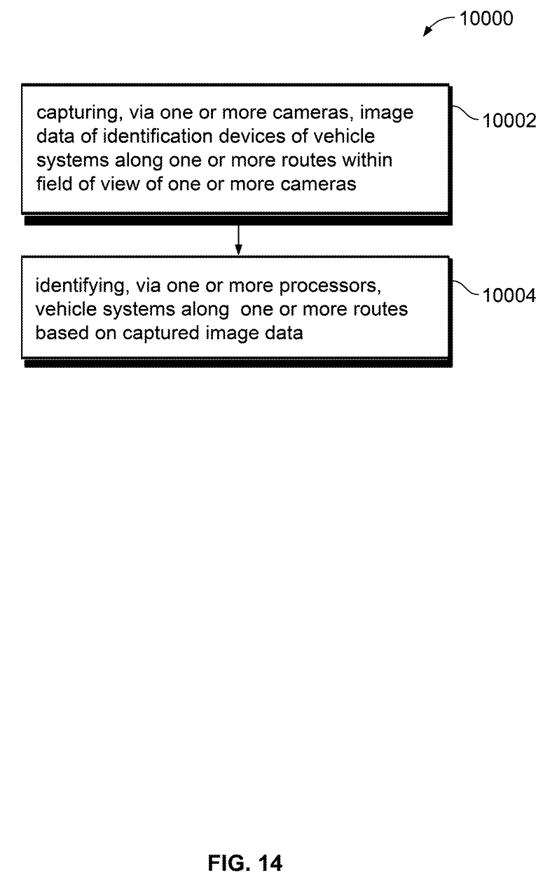

In one embodiment, FIG. 14 depicts a method 10000 for monitoring one or more vehicle systems along one or more routes, which may be executed by the controller of FIG. 3. The method includes capturing 10002, via one or more cameras, image data of identification devices of a plurality of vehicle systems along one or more routes within a field of view of the one or more cameras. The method further includes identifying 10004, via the one or more processors, the plurality of the vehicle systems along the one or more routes based on the captured image data. The method is executed in full or in part by the controller, as above recited.

In one embodiment, the one or more cameras includes a first camera having a first field of view directed toward an entry zone of a yard and a second camera having a second field of view directed toward a switching zone of the yard, and the method further includes capturing, via the first camera, the image data of the identification device of a vehicle system in the entry zone and capturing, via the second camera, the image data of the identification device of a vehicle system in the switching zone.

In one embodiment, the one or more cameras includes a first camera having a first field of view and a second camera having a second field of view different than the first field of view, and the method further includes combining, via the one or more processors, the image data from the first camera and the image data from the second camera, for instance, in real time, to identify a vehicle system of the plurality of vehicle systems.

In one embodiment, the method further includes operating the one or more cameras in at least one of a low light environment, a continuous time period, or all weather conditions.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system for identifying vehicle systems within a yard, comprising:
one or more cameras positioned at the yard and each having a field of view that includes at least a portion of one or more routes within the yard, the one or more cameras configured to capture image data of vehicle systems within the field of view; and
one or more processors configured to:
receive the image data captured by the one or more cameras;
detect, in the image data, identification devices positioned on exterior surfaces of the vehicle systems within the yard; and
identify the vehicle systems the yard based on the detected identification devices.

2. The monitoring system of claim 1, wherein the one or more processors are further configured to:
extract identification data from the identification devices detected in the image data, the identification data corresponding to a unique identity of a respective vehicle system; and
identify the vehicle systems within the yard by using the extracted identification data.

3. The monitoring system of claim 1, wherein the identification devices comprise markers or visual indicators positioned on the exterior surfaces of the vehicle systems, and wherein the one or more processors is further configured to identify the vehicle systems within the yard by identifying a respective vehicle system as an asset to be monitored based on detecting a respective one of the markers or visual indicators in the image data.

4. The monitoring system of claim 3, wherein the markers or visual indicators comprise at least one of a QR code, a bar code, a color block, or a shape.

5. The monitoring system of claim 1, wherein the one or more processors is further configured to analyze the image data received from the one or more cameras to determine a count metric for the yard, and wherein the count metric is associated with the vehicle systems identified in the field of view of the one or more cameras.

6. The monitoring system of claim 1, wherein the one or more processors is further configured to detect vehicle line up information associated with the vehicle systems based on the image data received from the one or more cameras.

7. The monitoring system of claim 1, comprising two or more cameras configured to capture the image data of the vehicle systems from two opposite sides of the one or more routes.

8. The monitoring system of claim 1, comprising a first camera with a first field of view and a second camera with a second field of view different than the first field of view, wherein the one or more processors is further configured to combine the image data from the first camera and the image data from the second camera in real time.

9. The monitoring system of claim 1, comprising a first camera with a first field of view directed toward an entry zone within the yard and a second camera with a second field of view directed toward a switching zone within the yard.

10. The monitoring system of claim 1, wherein the one or more vehicle system comprises a container or a cargo and a vehicle carrying the container or the cargo.

11. A monitoring system, comprising:
identification devices each determining unique identity data of a plurality of vehicle systems along one or more routes; and
one or more processors configured to:
receive the determined identity data of the plurality of vehicle systems from the identification devices; and
identify the plurality of vehicle systems along the one or more routes based on the received identity data of the plurality of vehicle systems.

12. The monitoring system of claim 11, wherein the identification devices comprise one or more of a marker, a visual indicator, a QR (Quick Response) code, a bar code, a color block, or a shape.

13. The monitoring system of claim 11, wherein the one or more processors is further configured to identify the plurality of vehicle systems along the one or more routes in at least one of a vehicle entry zone or a vehicle switching zone based on the received identity data of the plurality of the vehicle systems.

14. The monitoring system of claim 11, wherein the one or more processors is further configured to determine one or more of line-up information or counting information or movement information of the plurality of vehicle systems along the one or more routes based on the received identity data of the plurality of vehicle systems.

15. The monitoring system of claim 11, wherein the identification devices is further configured to operate in at least one of a low light environment, a continuous time period, or all weather conditions.

16. The monitoring system of claim 11, wherein the plurality of vehicle systems comprises a container or a cargo and a vehicle carrying the container or the cargo.

17. A method, comprising:
capturing, via one or more cameras, image data of identification devices of a plurality of vehicle systems along one or more routes within a field of view of the one or more cameras;
identifying, via the one or more processors, the plurality of the vehicle systems along the one or more routes based on the captured image data.

18. The method of claim 17, wherein the one or more cameras comprises a first camera having a first field of view directed toward an entry zone of a yard and a second camera having a second field of view directed toward a switching zone of the yard, wherein the method further comprises:
capturing, via the first camera, the image data of the identification device of a vehicle system in the entry zone; and
capturing, via the second camera, the image data of the identification device of a vehicle system in the switching zone.

19. The method of claim 17, wherein the one or more cameras comprises a first camera having a first field of view and a second camera having a second field of view different than the first field of view, wherein the method further comprises:
combining, via the one or more processors, the image data from the first camera and the image data from the second camera to idenitfy a vehicle system of the plurality of vehicle systems.

20. The method of claim 17 further comprising operating the one or more cameras in at least one of a low light environment, a continuous time period, or all weather conditions.
